(19) United States
(12) Patent Application Publication
(10) Pub. No.: US 2008/0316413 A1
(43) Pub. Date: Dec. 25, 2008

(54) Display panel

(75) Inventor: Jae Hyun CHO, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/150,205

(22) Filed: Apr. 24, 2008

(30) Foreign Application Priority Data
Jun. 22, 2007 (KR) 10-2007-0061824

(51) Int. Cl. G02F 1/1333

(52) U.S. Cl. 349/144

(57) ABSTRACT

A display panel having: three-color pixels sequentially arranged in a row direction, with a white pixel provided in an adjacent row. One or more gate lines extending in a row direction are associated with the three-color pixels; and a plurality of data lines extending in a columnar direction are associated with the respective three-color pixels, wherein the white pixel is coupled to the gate line and at least one of the plurality of data lines.

An RGBW pixel arrangement structure is implemented using a part of a plurality of signal lines assigned to the respective RGB pixels for a divided-pixel structure in order to control an additional white pixel.

This application claims priority to Korean Patent application No. 10-2007-0061824, filed on Jun. 22, 2007 in the Korean Intellectual Property Office and all of the benefits accruing therefrom under 35 U.S.C. 119. The contents of the foregoing application are herein incorporated by reference in their entirety.

### BACKGROUND OF THE INVENTION

1. Field of the Invention

The present invention relates to a display panel, and more particularly, to a display panel in which a white pixel is formed in addition to red, green and blue pixels.

2. Description of the Related Art

A liquid crystal display (LCD) is a device which displays images by controlling transmittance of incident light emitted from a light source using optical anisotropy of liquid crystal molecules and polarization characteristics of a polarizer. Recently, the application scope of LCDs has expanded since lightweight, slim size, high resolution and large screen size can be implemented in LCDs which have low power consumption.

In general, LCDs have a narrow viewing angle as compared to other display devices because light is transmitted only along a light transmitting axis of liquid crystal molecules to display images. Various technologies to improve the viewing angle of an LCD have been studied. One of the technologies is the patterned vertical alignment (PVA) mode. The PVA mode includes aligning liquid crystal molecules perpendicular to a substrate, forming a cutout or protrusion pattern respectively on a pixel electrode and a common electrode facing the pixel electrode, whereby distorting an electric field between the two electrodes to form multi-domain structure and resulting in the improvement of a narrow viewing angle. Although such a PVA mode shows better contrast ratio as compared to conventional twisted nematic (TN) mode or in-plane switching (IPS) mode, visibility, particularly side-visibility, of the PVA mode is known to be undesirable. Meanwhile, a super patterned vertical alignment (SPVA) mode includes forming a plurality of divided pixels in a unit cell, driving them independently, and applying data signals with different electric potential to the respective divided pixels. Thereby side-visibility can be improved, since each divided pixel is charged with different levels of voltage and the light transmitting axis of the liquid crystal molecule is controlled in various directions.

However, side-visibility is still not as good as is desired in spite of the improvement achieved by dividing the pixels. Since the visibilities of the red and green pixels are relatively low, a skin color band is not acceptably displayed. In the case of digital information display (DID) products, much higher brightness is required as compared to other types of products, such that an RGBW pixel arrangement structure with the additional white (W) pixel is more effective than a conventional RGB pixel arrangement structure where red (R), green (G) and blue (B) pixels are included. However, in the prior art when a white pixel (W) was additionally included in the conventional pixel arrangement structure, an additional signal line was required to control the white pixel. Accordingly the typical driving circuit used for RGB pixel arrangement structure could not be used.

### SUMMARY OF THE INVENTION

Aspects of the present invention provide a display panel having an RGBW pixel arrangement structure where a white pixel is added to an RGB pixel arrangement, and is capable of using a typical driving circuit for the RGB pixel arrangement structure.

Another aspect of the present invention provides a display panel wherein some of signal lines assigned to a blue pixel, which has better side-visibility, is redistributed to control an additional white pixel, so that brightness and side-visibility of all the color pixels can be improved while brightness and side-visibility of the blue pixel are not significantly lowered. According to an exemplary embodiment of the present invention, a display panel may include first, second and third pixels associated with a gate line and a plurality of data lines, respectively; and a white pixel which is coupled to the gate line and one of the plurality of data lines associated with a portion of the first, second and third pixels; wherein the first, second and third pixels and the white pixel are arranged adjacent to each other to configure a square-shaped structure.

The first, second and third pixels may include a red pixel, a green pixel and a blue pixel.

The red pixel and the green pixel include a plurality of divided pixels may be each comprised of a main pixel and a sub-pixel coupled to the plurality of data lines.

At least some of the first, second and third pixels are divided pixels comprising a main pixel portion and sub-pixel portion and further wherein a main data line and a sub-data line are associated respectively with the main pixel and sub-pixel of the divided pixels.

An image signal with different voltage may be supplied to the main pixel and the sub-pixel.

The white pixel may be selectively coupled to a data line associated with the blue pixel.

The plurality of data lines may include a main data line and a sub-data line, and the white pixel may be connected to the sub-data line. The white pixel is disposed parallel to and elongated along the extending direction of the gate lines. And even number of data lines are disposed across the white pixel region.

The display panel may further include: a lower substrate where the gate lines and the data lines are disposed thereon; an upper substrate facing the lower substrate; and a liquid crystal layer disposed between the lower and the upper substrate, and vertically aligned with respect to the lower and the upper substrates.

The display panel may further include: a pixel electrode disposed on the lower substrate; and a common electrode disposed on the upper substrate, wherein a cutout or a protrusion pattern is formed on one or both of the pixel electrode and the common electrode.

The first, second and third pixels may be arranged sequentially in a first row, and the white pixel is arranged in a second row adjacent to the first row.

Two of the first, second and third pixels may be arranged sequentially in a first row, and the other one of the first, second and third pixels and the white pixel are arranged in a second row adjacent to the first row.

A display panel may include: first, second and third pixels associated with a plurality of gate lines and a data line, respectively; and a white pixel which is coupled to the data line and one of the plurality of gate lines associated with a portion of the first, second and third pixels; wherein the first, second and third pixels and the white pixel are arranged adjacent to each other to configure a square-shaped structure. The first, second and third pixels may include a red pixel, a green pixel and a blue pixel. The red pixel and the green pixel comprise a plurality of divided pixels coupled to the plurality of gate lines respectively. The plurality of gate lines may include a main gate line and a sub-gate line; each of the plurality of divided pixels comprise a main pixel coupled to the main gate line and a sub-pixel coupled to the sub-gate line; the main gate line is coupled to the main pixels of the red and green pixels; and the sub-gate line is coupled to the white pixel. Image signals having different voltage levels may be supplied to the main pixel and the sub-pixel

The plurality of gate lines may include a main gate line and a sub-gate line, and the white pixel may be coupled to the sub-gate lines.

The white pixel may be disposed parallel to and elongated along the extending direction of the gate lines. An even number of data lines are disposed across the white pixel region. The first, second and third pixels and the white pixel have identical areas.

The display panel may further include: a lower substrate where the gate lines and the data lines are disposed thereon; an upper substrate facing the lower substrate; and a liquid crystal layer disposed between the lower and the upper substrates, and vertically aligned with respect to the lower and the upper substrates.

The display panel may further include: a pixel electrode disposed on the lower substrate; and a common electrode disposed on the upper substrate, wherein a cutout or a protrusion pattern is formed on one or both of the pixel electrode and the common electrode. The first, second and third pixels are arranged sequentially in a first row, and the white pixel is arranged in a second row adjacent to the first row.

### BRIEF DESCRIPTION OF THE DRAWINGS

Exemplary embodiments of the present invention can be understood in more detail from the following description taken in conjunction with the accompanying drawings, in which:

FIG. 1 is a partial plan view of a liquid crystal display panel according to a first exemplary embodiment of the present invention;

FIG. 2 is a sectional view of the liquid crystal display panel along line I-I′ shown in FIG. 1;

FIG. 3 is a sectional view of the liquid crystal display panel along line II-II′ shown in FIG. 1;

FIG. 4 is a partial plan view of a liquid crystal display panel according to a second exemplary embodiment of the present invention;

FIG. 5 is a sectional view of the liquid crystal display panel along line III-III′ shown in FIG. 4.

### DETAILED DESCRIPTION OF THE PREFERRED EMBODIMENTS

Hereinafter, preferred embodiments of the present invention are described in detail with reference to the accompanying drawings.

However, the present invention is not limited to the embodiments described below but will be implemented in various different forms. The embodiments are provided only to complete the disclosure of the present invention and fully convey the scope of the present invention to those skilled in the art. Like reference numerals designate like elements in the drawings.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

### First Embodiment

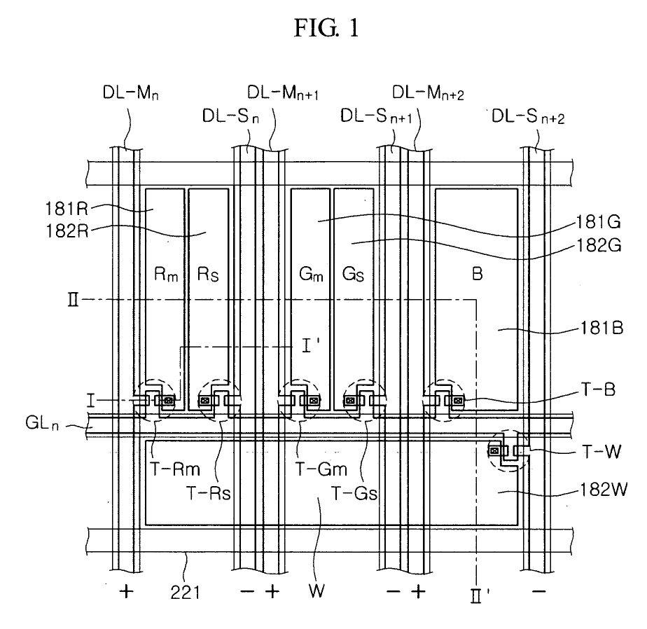

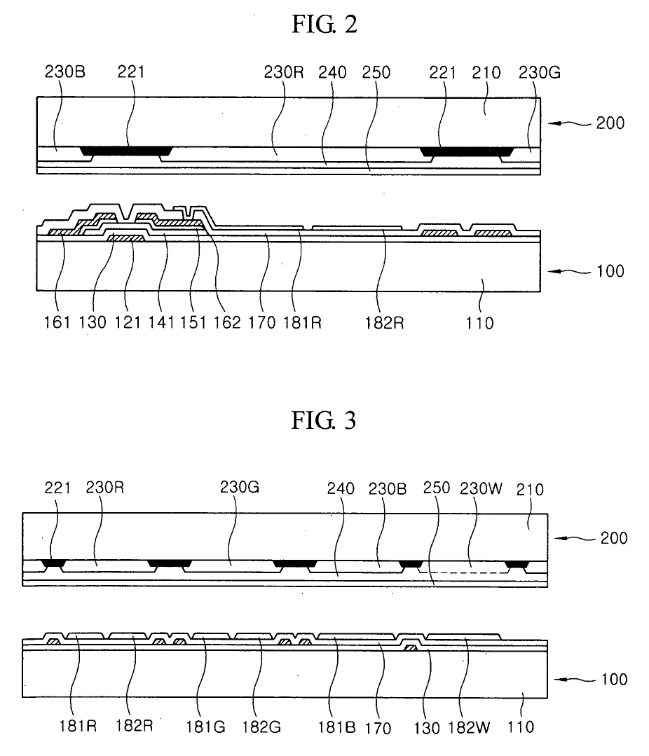

FIG. 1 is a partial plan view of a liquid crystal display panel according to a first exemplary embodiment of the present invention, FIG. 2 is a sectional view of the liquid crystal display panel along line I-I′ shown in FIG. 1, and FIG. 3 is a sectional view of the liquid crystal display panel along line II-II′ shown in FIG. 1.

Referring to FIGS. 1 to 3, the liquid crystal display panel includes: an upper substrate 200 on which a common electrode 250 is disposed; a lower substrate 100 facing the upper substrate 200 and having pixel electrodes 181, 182 disposed thereon; and a liquid crystal layer (not shown) interposed between the upper substrate 200 and the lower substrate 100.

The upper substrate 200 includes a light-transmitting insulation substrate 210, a black matrix 221 formed on the substrate 210, a color filter 230 formed on the black matrix 221 and a common electrode 250 formed on the color filter 230.

The color filter 230 displays one of the three primary colors specifically and the display panel may be configured to implement full colors by combinations thereof. For example, the color filter 230 includes a red color filter 230R, a green color filter 230G and a blue color filter 230B. In particular, in the present embodiment, the color filter 230 further includes a white color filter 230W in addition to the three primary color filters 230R, 230G and 230B. The white color filter 230W can be formed by omitting or removing an organic film for color filter in an associated region.

The black matrix 221 is formed between the color filters 230. The black matrices 221 block a leakage of light between adjacent color filters, for example, 230R-230G, 230G-230B, 230B-230R and so forth, and prevent light interference.

An overcoat layer 240 may be formed between the color filter 230 and the common electrode 250 to improve adhesion and uniformity of the interface. Further, column spacers (not shown) having a predetermined height to maintain a cell gap may be disposed on the overcoat layer 240. The column spacers may be disposed on any of the upper and the lower substrates 200 and 100. When the column spacers are disposed on the upper substrate 200, they may be disposed on the black matrix 221, the color filter 230, the overcoat layer 240 or the common electrode 250.

The lower substrate 100 includes: a light-transmitting insulating substrate 110; a plurality of gate lines GL formed parallel to each other extending along a direction (e.g., row direction) on the substrate 110; and a plurality of data lines DL formed parallel to each other extending along another direction (e.g., columnar direction) on the substrate 110. A pixel region is defined at each crossing region of the gate lines GL and the data lines DL. A thin film transistor T, a pixel electrode 181, 182, and a storage electrode (not shown) are disposed in the pixel region. Moreover, a first insulating layer 130 is formed between the gate line GL and the data line DL, and a second insulating layer 170 is formed between the data line DL and the pixel electrode 181,182 for insulation between layers.

The thin film transistor T includes: a gate electrode 121; a first insulating layers 130, an active layer 141 and an ohmic contact layer 151 formed on the gate electrode 121; and a source electrode 161 and a drain electrode 162 formed on both sides of the ohmic contact layer 151. The gate electrode 121 is connected to the gate line GL, the source electrode 161 is connected to the data line DL, and the drain electrode 162 is connected to the pixel electrode 181 or 182 via a contact hole. When a predetermined gate signal is supplied to the gate electrode 121 through the gate line GL, a conductive path is formed in the active layer 141, and then a given data signal can be supplied to the pixel electrode 181 or 182 through the data line DL.

The pixel electrodes 181, 182 and the common electrode 250 disposed on the facing substrate 200 forms a liquid crystal capacitor together. Such a liquid crystal capacitor is charged with a data signal to control an arrangement of the liquid crystals.

A storage electrode (not shown) is connected to a storage line (not shown) extending parallel to the gate line GL and supplied with a reference voltage which is the same as a common voltage. The storage electrode and the pixel electrode 181 and 182 disposed on the storage electrode forms a storage capacitor Cst, and keep the data signal charged in the pixel electrode 181, 182 until the next data signal is charged. The storage capacitor Cst may be omitted if necessary.

A liquid crystal layer (not shown) is formed by injecting liquid crystal between the upper substrate and the lower substrate 200 and 100, which are cohered together, so as to be spaced apart by a predetermined distance. The liquid crystal layer in the present exemplary embodiment may be aligned so that a longer axis of the liquid crystal molecule is vertically arranged with respect to the upper and the lower substrates 200 and 100, and a tilting direction of the liquid crystal molecule is dispersed in various directions. That is, a multi-domain structure may be desirable. To form the multi-domain structure, although not shown, an alignment-controlling means for liquid crystal molecules such as a cutout pattern or a protrusion pattern may be provided on the facing surfaces of the upper and the lower substrates 200 and 100, for example, on at least one of the common electrode 250 and the pixel electrode 181 and 182. The alignment-controlling means for liquid crystal molecules improves a viewing angle by dispersing the tilting directions of the liquid crystal molecules in various directions.

As shown in FIG. 1, there are provided three-color pixels sequentially arranged along a row direction on a liquid crystal display panel. The three-color pixels include a red pixel R, a green pixel G, and a blue pixel B. Some of the three-color pixels R, G, and B may have a plurality of divided pixels. For example, main pixels and sub-pixels may be provided in the red pixel R and the green pixel G having a relatively low side-visibility. The main pixel of the red pixel R includes a main thin film transistor T-Rm and a main pixel electrode 181R. The sub-pixel of the red pixel R includes a sub-thin film transistor T-Rs and a sub-pixel electrode 182R. The main pixel of the green pixel G includes a main thin film transistor T-Gm and a main pixel electrode 181G. The sub-pixel of the green pixel G includes a sub-thin film transistor T-Gs and a sub-pixel electrode 182G. Therefore, one gate line GL and two data lines DL-M and DL-S may be assigned to each of the three-color pixels R, G, and B to control the main pixel and the sub-pixel independently (1G-2D structure). The gate line GL is assigned to the main pixel and the sub-pixel in common, and the two data lines DL-M and DL-S are assigned to the main pixel and the sub-pixel, respectively. That is, gate electrodes of the main thin film transistors T-Rm and T-Gm and gate electrode of the sub-thin film transistors T-Rs and T-Gs are connected to the same gate line GL. A source electrode of the main thin film transistors T-Rm and T-Gm is connected to the main data line DL-M, and a source electrode of the sub-thin film transistors TRs and T-Gs is connected to the sub-data line DL-S. Different levels of voltages are supplied to the main pixel and the sub-pixels, respectively, as a data signal (i.e., an image signal). For example, a data signal having a low voltage level is supplied to the main pixel and a data signal having a high voltage level is supplied to the sub-pixel. Therefore, different electric fields are generated in a pixel region so that arrangement of the liquid crystal molecules can be controlled in various directions, whereby side-visibility as well as front-visibility are more improved. Alternately, a data signal having a high voltage level may be supplied to the main pixel and a data signal having a low voltage level may be supplied to the sub-pixel.

In a liquid crystal display panel of the present exemplary embodiment, a white pixel is provided in the next row in addition to the three-color pixels sequentially arranged in a row direction. Each of the pixels R, G, B, and W may be formed to have the same area. Each of the pixels R, G, B, and W may be formed parallel to an extending direction of a data line DL, and a white pixel W may be formed parallel to and elongated along an extending direction of a gate line GL. Even number of data lines DL-Sn, DL-Mn+1, DL-Sn+1 and DL-Mn+2 may be disposed across a white pixel region. Therefore, four-color pixels R, G, B, and W including the three-color pixels R, G, and B and the white pixel W may be disposed so as to approximately form a square shape. An extra signal line DL-Sn+2 and a common signal line GLn that are assigned to the pixels not having a divided pixel structure among the three-color pixels R, G, and B, i.e., the blue pixel B, are assigned to the white pixel W for controlling the white pixel W. Thereby the white pixel W can be configured to operate as a main pixel or a sub-pixel of the blue pixel B. For example, in the present exemplary embodiment, the white pixel W is configured to operate as a sub-pixel of the blue pixel B. A source electrode of a thin film transistor T-B provided in the blue pixel B is connected to the main data line DL-Mn+2 of the blue pixel B, and a drain electrode is connected to the pixel electrode 181B of the blue pixel B. A source electrode of a thin film transistor T-W provided in the white pixel W is connected to the sub-data line DL-Sn+2 of the blue pixel B, and a drain electrode is connected to the pixel electrode 182W of the white pixel W. Gate electrodes of the thin film transistors T-B and T-W provided in the blue pixel and the white pixel W are connected in common to the same gate line GLn, thereby no additional signal line is needed for controlling the white pixel W. In other words, the 1G-2D structure used for the conventional RGB pixel arrangement can still be used. Since the blue pixel B has a relatively better side-visibility as compared to the red pixel R and the green pixel G, desirable side-visibility can be achieved without employing the divided pixel structure. Therefore, the extra signal line DL-Sn+2 assigned to the blue pixel and the common signal line can be used for controlling the white pixel W, even without forming an additional sub-pixel in the blue pixel B. Moreover, since white light displayed by the white pixel W has all of the three primary colors therein, it can complement the red, green, and blue lights displayed by the three-color pixels R, G, and B, so that the brightness of a displayed image and the side-visibility can be further improved. In the liquid crystal display panel of the present exemplary embodiment, an RGBW pixel structure can be implemented by employing the wiring structure according to the conventional RGB pixel arrangement structure. Manufacturing cost can be reduced since the driving circuit for the conventional RGB pixel arrangement can still be used. In particular, the liquid crystal display panel according to this embodiment is expected to be more effective when it is employed in digital information display (DID) products requiring superior brightness and side-visibility as compared to others.

Brief description of an operating scheme of a unit pixel in such a configuration of liquid crystal display panel is as follows.

A predetermined level of voltage is applied to the pixel electrodes 181 and 182 of a unit pixel as a data signal according to a display gradation. A reference voltage Vcom is applied to the common electrode 250. As such, an electric field is formed between the pixel electrodes 181 and 182 and the common electrode 250, so that a light transmittivity is controlled to display a desired color. The data signal is supplied to the pixel electrodes 181 and 182 by a space-dividing mode through a plurality of data lines DL-M and DL-S assigned to the respective three-color pixels R, G, and B. That is, when a gate signal (or a gate turn-on voltage) is delivered through the common gate line GLn, the respective transistors T-Rm, T-Rs, T-Gm, T-Gs, T-B and T-W are turned on. The transistors T-Rm, T-Rs, T-Gm, T-Gs, T-B and T-W are provided respectively in a red pixel R, a green pixel G, a blue pixel B, and a white pixel W that are connected to the common gate line GLn. A main data signal is supplied to the respective pixel electrodes 181R and 181G of a red main pixel Rm and a green main pixel Gm through the main data line DL-Mn and DL-Mn+1 assigned to the corresponding pixels, respectively. A sub-data signal is supplied to the respective pixel electrodes 182R and 182G of a red sub-pixel Rs and a green sub-pixel Gs through the sub-data lines DL-Sn and DL-Sn+1 assigned to the corresponding pixels, respectively. Meanwhile, a blue data signal is supplied to the pixel electrode 181B of the blue pixel B through the main data line DL-Mn+2 assigned to the corresponding pixel, and a white data signal is supplied to the pixel electrode 182W of the white pixel W through the sub-data line DL-Sn+2 assigned to the blue pixel. The data signal may be supplied to the respective pixels 181 and 182 by reversing polarity at a time difference in order to prevent deterioration due to a remnant DC. That is, a pair of data signals having a positive polarity (+) and a negative polarity (−) with respect to the reference voltage 250 may be supplied alternately dot-by-dot, line-by-line, column-by-column or frame-by-frame. As described above, in the liquid crystal display panel according to the present exemplary embodiment, an even number of data lines DL-Sn, DL-Mn+1, DL-Sn+1 and DL-Mn+2 is formed across the white pixel W region. In the case where the polarity of the data signal charged in a unit pixel is controlled by the reversing mode, the positive polarity (+) voltage and the negative polarity (−) voltage, which is supplied through the even number of data lines DL-Sn, DL-Mn+1, DL-Sn+1 and DL-Mn+2, compensates each other, so that pixel deterioration caused by accumulation of a specific polarity voltage can be prevented.

### Second Embodiment

Although an RGBW pixel arrangement structure described above is based on the liquid crystal display panel having 1G-2D structure in the first embodiment, the present invention is not limited thereto but may be modified into different forms. Hereinafter, a liquid crystal display panel having 2G-1D structure is described as an example of such various modifications. Overlapping descriptions will be skipped or briefly explained.

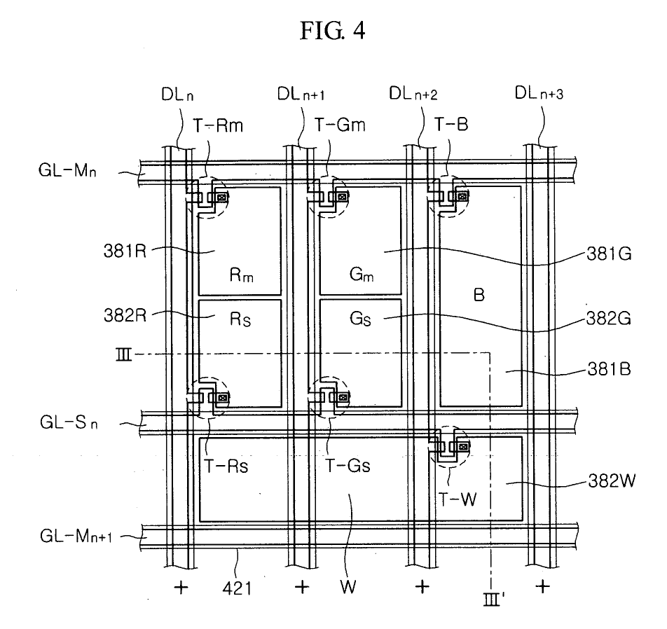

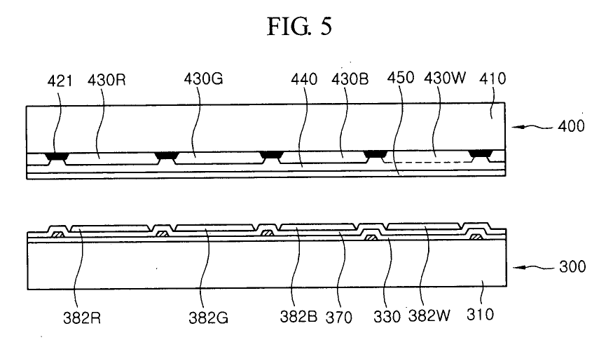

FIG. 4 is a partial plan view of a liquid crystal display panel according to a second exemplary embodiment of the present invention and FIG. 5 is a sectional view of the liquid crystal display panel along line III-III′ shown in FIG. 4.

Referring to FIGS. 4 and 5, the liquid crystal display panel includes: an upper substrate 400 having a common electrode 450 disposed thereon; a lower substrate 300 facing the upper substrate 400 and having a pixel electrode 360 disposed thereon; and a liquid crystal layer (not shown) interposed between the upper substrate 400 and the lower substrate 300.

There are provided three-color pixels R, G, and B including a red pixel R, a green pixel G, and a blue pixel B sequentially arranged in the row direction on the liquid crystal display panel. Some of the three-color pixels R, G, and B may include a plurality of divided pixels. For example, main pixels and sub-pixels may be provided in the red pixel R and the green pixel G having a relatively low side-visibility. The main pixel of the red pixel R includes a main thin film transistor T-Rm and a main pixel electrode 381R. The sub-pixel of the red pixel R includes a sub-thin film transistor T-Rs and a sub-pixel electrode 382R. The main pixel of the green pixel G includes a main thin film transistor T-Gm and a main pixel electrode 381G. The sub-pixel of the green pixel G include a sub-thin film transistor T-Gs and a sub-pixel electrode 382G. To control the main pixel and the sub-pixel independently, two gate lines GL-M and GL-S and one data line DL may be assigned to each of the three-color pixels R, G, and B (2G-1D structure). The two gate lines GL-M and GL-S are assigned to the main pixel and the sub-pixel respectively, and the one data line DL is assigned to the main pixel and the sub-pixel in common. That is, a gate electrode of the main thin film transistor T-Rm and T-Gm is connected to the main gate line GL-M, and a gate electrode of the sub-thin film transistor T-Rs and T-Gs is connected to the sub-gate line GL-S. Source electrodes of the main thin film transistor T-Rm and the sub-thin film transistor T-Rs of the red pixel are connected in common to the same data line DLn. Source electrodes of the main thin film transistor T-Gm and the sub-thin film transistor T-Gs of the green pixel are connected to the same data line DLn+1 in common. Gate signals having a different voltage level are supplied to the main gate line GL-M and the sub-gate line GL-S respectively, so that the main pixel and the sub-pixel can be controlled to be charged with different voltages.

Particularly, in the liquid crystal display panel according to this exemplary embodiment, a white pixel is additionally provided in the next row of a predetermined row in which the three-color pixels R, G, and B are arranged. It is preferable that each pixel R, G, B, and W is formed to have the same area. Further, each of the three-color pixels R, G, and B may be disposed to be parallel to the extending direction of the data line DL, and the white pixel W may be disposed to be parallel to and elongated along the extending direction of the gate line GL. Even number of data lines DLn+1 and DLn+2 may be disposed across the white pixel W region. Accordingly, the four-color pixels R, G, B, and W including the three-color pixels R, G, and B and the white pixel W are disposed to form a square shape approximately. An extra signal line GL-Sn assigned to some pixels not, having divided pixel structure among the three-color pixels R, G and B, i.e., the blue pixel B, and the common signal line DLn+2 are assigned to the white pixel W and used for controlling the white pixel W. Thereby the white pixel W can be configured to operate like a main pixel or a sub-pixel of the blue pixel B. For example, in this exemplary embodiment, the white pixel W is configured to operate like a sub-pixel of the blue pixel B. A gate electrode of the thin film transistor T-B provided in the blue pixel B is connected to the main gate line GL-Mn of the blue pixel, and the drain electrode is connected to a pixel electrode 381B of the blue pixel B. A gate electrode of the thin film transistor T-W provided in the white pixel W is connected to the sub-gate line GL-Sn of the blue pixel, and a drain electrode is connected to a pixel electrode 382W of the white pixel W. Source electrodes of the respective thin film transistors T-B and T-W provided in the blue pixel B and the white pixel W are connected to the same data line DLn+2. Therefore, an additional signal line for controlling the white pixel W is not needed, and the 2G-1D structure according to the conventional RGB pixel arrangement structure can still be used. Since the blue pixel B has relatively better side-visibility as compared to the red pixel R and the green pixel G, desirable side-visibility can be achieved without employing the divided pixel structure. Therefore, the extra signal line GL-Sn assigned to the blue pixel and a common signal line DLn+2 can be used for controlling the white pixel W without additionally forming sub-pixel in the blue pixel B. Moreover, since white light displayed by the white pixel W has all of the three primary colors therein, it can complement the red, green, and blue lights displayed by the three-color pixels R, G and B, so that brightness of a displayed image and side-visibility can be further improved.

An operation process of a unit pixel in a liquid crystal display panel having such a configuration will be described briefly as follows.

Data signal is supplied to each unit pixel R, G, B, and W by time-dividing mode through a plurality of gate lines GL-M and GL-S that are assigned to the respective three-color pixels R, G, and B. When a gate signal is delivered through the main gate line GL-Mn, each of the thin film transistor T-Rm, T-Gm and T-B, which is respectively connected to the red main pixel Rm, the green main pixel Gm and the blue pixel B, is turned on. The main data signal is supplied to the pixel electrodes 381R and 381G of the red main pixel Rm and the green main pixel Gm through the data lines DLn and DLn+1 assigned to the corresponding pixels. Further, a blue data signal delivered through the data line DLn+2 is supplied to the pixel electrode 381B of the blue pixel B. When a sub-gate signal is delivered at a time interval through the sub-gate line GL-Sn, then the respective transistors T-Rs, T-Gs and T-W of the red sub-pixel Rs, the green sub-pixel Gs and the white pixel W are turned on. A sub-data signal is supplied to the pixel electrodes 382R and 382G of the red sub-pixel Rs and the green sub-pixel Gs through the data lines DLn and DLn+1 assigned to the corresponding pixels. Furthermore, a white data signal delivered through the data line DLn+2, which is assigned to the blue pixel B, is supplied to the pixel electrode 382W of the white pixel W. Meanwhile, the polarity of the data signal supplied to the respective pixel electrodes 381 and 382 may be reversed at predetermined time intervals to prevent deterioration due to remnant DC. A pair of data signals having positive (+) and negative (−) polarity with respect to the reference voltage supplied to the common electrode 450 may be supplied alternately dot-by-dot, line-by-line, column-by-column or frame-by-frame. As described above, the liquid crystal display panel according to this exemplary embodiment is configured so that even number of data lines DLn+1 and DLn+2 are disposed across the white pixel W region. Therefore, the positive (+) voltage and the negative (−) voltage supplied through the even number of data lines DLn+1 and DLn+2 offset each other to prevent pixel deterioration due to an accumulation of voltage of a specific polarity, even though the polarity of the voltage of the signal is controlled in an inversion mode.

### Third Embodiment

FIG. 6 is a partial plan view of a liquid crystal display panel according to a third exemplary embodiment of the present invention. Referring to FIG. 6, the liquid crystal display panel is configured to have a square-shaped RGBW arrangement structure. In the RGBW arrangement structure, two of three-color pixels R, G and B are arranged sequentially in a first row, and the other one of the three-color pixels R, G and B and the white pixel are arranged sequentially in a second row adjacent to the first row. The liquid crystal display panel includes a first gate line GLn which is associated with the pixels arranged in the first row; a second gate line GLn+1 which is associated with the pixels arranged in the second row; and a plurality of data lines DL which is associated with the three-color pixels R, G and B. The white pixel W is coupled to the first gate line GLn and one of the plurality of data lines which is associated with one of the pixels in the first row.

In the liquid crystal display panel in accordance with the third exemplary embodiment, the red pixel R and the blue pixel B are arranged sequentially in the first row, and the green pixel G and the white pixel are arranged sequentially in the second row adjacent to the first row, which configures a square-shaped structure.

The three-color pixels include a red pixel R, a green pixel G, and a blue pixel B. Some of the three-color pixels R, G, and B may have a plurality of divided pixels. For example, main pixels and sub-pixels may be provided in the red pixel R and the green pixel G having a relatively low side-visibility. The main pixel of the red pixel R includes a main thin film transistor T-Rm and a main pixel electrode 581R. The sub-pixel of the red pixel R includes a sub-thin film transistor T-Rs and a sub-pixel electrode 582R. The main pixel of the green pixel G includes a main thin film transistor T-Gm and a main pixel electrode 581G. The sub-pixel of the green pixel G includes a sub-thin film transistor T-Gs and a sub-pixel electrode 582G. Therefore, one gate line GLn or GLn+1 and two data lines DL-M and DL-S may be assigned to each of the three-color pixels R, G, and B to control the main pixel and the sub-pixel independently (1G-2D structure). The gate line GLn or GLn+1 is assigned to the main pixel and the sub-pixel in common, and the two data lines DL-M and DL-S are assigned to the main pixel and the sub-pixel, respectively. An extra signal line DL-Sn+1 and a common signal line GLn that are assigned to the pixels which do not have a divided pixel structure among the three-color pixels R, G, and B, i.e., the blue pixel B, are assigned to the white pixel W for controlling the white pixel W. Thereby the white pixel W can be configured to operate as a main pixel or a sub-pixel of the blue pixel B. For example, in the present exemplary embodiment, the white pixel W is configured to operate as a sub-pixel of the blue pixel B. A source electrode of a thin film transistor T-B provided in the blue pixel B is connected to the main data line DL-Mn+1 of the blue pixel B, and a drain electrode is connected to the pixel electrode 581B of the blue pixel B. A source electrode of a thin film transistor T-W provided in the white pixel W is connected to the sub-data line DL-Sn+1 of the blue pixel B, and a drain electrode is connected to the pixel electrode 582W of the white pixel W. Gate electrodes of the thin film transistors T-B and T-W provided in the blue pixel and the white pixel W are connected in common to the same gate line GLn, thereby no additional signal line is needed for controlling the white pixel W.

Although a liquid crystal display device has been described above as an example of various display devices according to the exemplary embodiments of the invention, the present invention is not limited thereto and can be applicable to various display devices having RGBW pixel arrangement structure, such as plasma display panel (PDP), organic electro luminescence (EL) device and so forth.

Although the invention has been described with reference to the accompanying drawings and the exemplary embodiments, the invention is not limited thereto, but is defined by the appended claims. Therefore, it should be noted that various changes and modifications can be made by those skilled in the art without departing from the technical spirit of the appended claims.

As described above, according to an aspect of the present invention, an RGBW pixel arrangement structure is implemented by using a part of a plurality of signal lines, which is assigned to the respective RGB pixels of a divided pixel structure, in order to control an additional white pixel. Thereby a typical driving circuit according to a conventional RGB pixel arrangement structure can be used, so that the manufacturing cost can be reduced.

According to another aspect of the present invention, the RGBW pixel arrangement structure is implemented by using a part of signal lines assigned to a blue pixel in order to control a white pixel instead of employing a divided pixel structure in the blue pixel which has relatively better side-visibility among the RGB pixels. Accordingly, overall brightness and side-visibility for full color bands can be further improved without significant deterioration of brightness and side-visibility of the blue color band.

What is claimed is:

1. A display panel comprising:
first, second and third pixels associated with a gate line and a plurality of data lines, respectively; and
a white pixel which is coupled to the gate line and one of the plurality of data lines associated with a portion of the first, second and third pixels;
wherein the first, second and third pixels and the white pixel are arranged adjacent to each other to configure a square-shaped structure

2. The display panel of claim 1, wherein the first, second and third pixels comprise a red pixel, a green pixel, and a blue pixel.

3. The display panel of claim 2, wherein the red pixel and the green pixel are each comprised of a main pixel and a sub-pixel coupled to the plurality of data lines.

4. The display panel of claim 1, wherein at least some of the first, second and third pixels are divided pixels comprising a main pixel portion and sub-pixel portion; and
a main data line and a sub-data line are associated respectively with the main pixel and sub-pixel of the divided pixels.

5. The display panel of claim 4, wherein image signals having different voltage are supplied to the main pixel and the sub-pixel.

6. The display panel of claim 1, wherein the white pixel is selectively coupled to a data line associated with the blue pixel.

7. The display panel of claim 6, wherein the plurality of data lines comprises a main data line and a sub-data line, and the white pixel is connected to the sub-data line.

8. The display panel of claim 1, wherein the white pixel is disposed parallel to and elongated along the extending direction of the gate lines.

9. The display panel of claim 1, wherein even number of data lines are disposed across the white pixel region.

10. The display panel of claim 1, wherein the first, second and third pixels and the white pixel have identical areas.

11. The display panel of claim 1 further comprising:
a lower substrate where the gate lines and the data lines are disposed thereon;
an upper substrate facing the lower substrate; and
a liquid crystal layer disposed between the lower and the upper substrate, and vertically aligned with respect to the lower and the upper substrates.

12. The display panel of claim 11 further comprising:
a pixel electrode disposed on the lower substrate; and
a common electrode disposed on the upper substrate,
wherein a cutout or a protrusion pattern is formed on one or both of the pixel electrode and the common electrode.

13. The display panel of claim 1, wherein the first, second and third pixels are arranged sequentially in a first row, and the white pixel is arranged in a second row adjacent to the first row.

14. The display panel of claim 1, wherein two of the first, second and third pixels are arranged sequentially in a first row, and the other one of the first, second and third pixels and the white pixel are arranged in a second row adjacent to the first row.

15. A display panel comprising:
first, second and third pixels associated with a plurality of gate lines and a data line, respectively; and
a white pixel which is coupled to the data line and one of the plurality of gate lines associated with a portion of the first, second and third pixels;
wherein the first, second and third pixels and the white pixel are arranged adjacent to each other to configure a square-shaped structure.

16. The display panel of claim 15, wherein the first, second and third pixels comprise a red pixel, a green pixel and a blue pixel.

17. The display panel of claim 16, wherein the red pixel and the green pixel comprise a plurality of divided pixels coupled to the plurality of gate lines respectively.

18. The display panel of claim 17, wherein the plurality of gate lines comprises a main gate line and a sub-gate line;
each of the plurality of divided pixels comprise a main pixel coupled to the main gate line and a sub-pixel coupled to the sub-gate line;
the main gate line is coupled to the main pixels of the red and green pixels; and
the sub-gate line is coupled to the white pixel.

19. The display panel of claim 18, wherein image signals having different voltage levels are supplied to the main pixel and the sub-pixel.

20. The display panel of claim 18, wherein the plurality of gate lines comprises a main gate line and a sub-gate line, and the white pixel is coupled to the sub-gate line.

21. The display panel of claim 15, wherein the white pixel is disposed parallel to and elongated along the extending direction of the gate lines.

22. The display panel of claim 15, wherein an even number of data lines are disposed across the white pixel region.

23. The display panel of claim 15, wherein the first, second and third pixels and the white pixel have identical areas.

24. The display panel of claim 15 further comprising:
a lower substrate where the gate lines and the data lines are disposed thereon;
an upper substrate facing the lower substrate; and
a liquid crystal layer disposed between the lower and the upper substrates, and vertically aligned with respect to the lower and the upper substrates.

25. The display panel of claim 24 further comprising:
a pixel electrode disposed on the lower substrate; and
a common electrode disposed on the upper substrate,
wherein a cutout or a protrusion pattern is formed on one or both of the pixel electrode and the common electrode.

26. The display panel of claim 15, wherein the first, second and third pixels are arranged sequentially in a first row, and the white pixel is arranged in a second row adjacent to the first row.
